(19) United States
(12) Patent Application Publication
(10) Pub. No.: US 2015/0186019 A1
(43) Pub. Date: Jul. 2, 2015

(54) METHOD AND APPARATUS FOR MANIPULATING AND PRESENTING IMAGES INCLUDED IN WEBPAGES

(71) Applicant: TENCENT TECHNOLOGY (SHENZHEN) COMPANY LIMITED, Shenzhen (CN)

(72) Inventors: Huateng MA, Shenzhen (CN); Ning ZHANG, Shenzhen (CN); Zhenxing ZHOU, Shenzhen (CN); Yuelong TENG, Shenzhen (CN); Jinzhou JIANG, Shenzhen (CN)

(21) Appl. No.: 14/656,350

(22) Filed: Mar. 12, 2015

Related U.S. Application Data
(63) Continuation of application No. PCT/CN2013/083298, filed on Sep. 11, 2013.

(30) Foreign Application Priority Data
Sep. 12, 2012 (CN) 201210336187.3

(51) Int. Cl. G06F 3/0484; G06F 17/30; G06F 17/22

(52) U.S. Cl. CPC G06F 3/04845; G06F 17/2247; G06F 3/04842; G06F 17/3089

(57) ABSTRACT

According to an example, a webpage which includes at least one image is loaded. A request for manipulating an image in the webpage is received, and a window that has at least one command interface for manipulating images is established. The image in the webpage is identified by using the request, and is loaded into the window that has the at least one command interface. When a command is received via one of the at least one command interface, a processing corresponding to the command is performed on the image, and the processed image is presented in the window.

### RELATED DOCUMENT INFORMATION

This application is a continuation application of International Patent Application No. PCT/CN2013/083298 filed on Sep. 11, 2013, which claims priority to Chinese Patent Application No. 201210336187.3, filed on Sep. 12, 2012, where the contents of said applications are herein incorporated by reference in their entireties.

### FIELD

The present disclosure relates to computer networks, and particularly, to a method and an apparatus for manipulating and presenting images included in webpages.

### BACKGROUND

A client device may obtain all kinds of information from a computer network and present the information in a webpage via a browser to a user. A webpage loaded by a browser of a client may include text and images. With the developments in the computer networks, users are more and more focusing on content and the quality of multi-media information in webpages, especially images. When a user browses an image in a webpage by using a client after the webpage is transmitted to the client by a network side device via a computer network, there may be situations where details of an image in the webpage may not be completely presented, the image may not have been through necessary processing, or the presented image is obscure and so on. When a webpage is presented by a browser in the client device, the manner of presenting an image in the webpage is pre-defined by a network side device in the computer network and transmitted in the webpage. The manner of presenting an image may specify at least one allowed manipulating operation such as zooming or rotating an image and the like. The manner of presenting an image in a webpage is configured in a simple way and cannot be changed in order to reduce the amount of data of the webpage and to reduce the bandwidth needed for transmitting the webpage in the computer network.

When a user wants to perform a control operation on an image in a webpage while browsing the webpage presented in a browser of a client, the user can only perform an operation that is defined in the presenting manner pre-defined for the image. For example, the image can be zoomed only when the presenting manner only defines zooming; the image can be rotated only when the presenting manner only defines rotating.

### SUMMARY

Embodiments of the present disclosure provide a method for manipulating and presenting images in webpages to enable a client to manipulate the presenting of an image in a webpage easily.

The technical schemes of this disclosure are as follows.

A method for manipulating and presenting images included in webpages may include:

loading a webpage which includes at least one image;

receiving a request for operating an image in the webpage, establishing a window which includes at least one command interface for image manipulation;

identifying the image in the webpage based on the request, loading the image into the window established to present the image in the window;

wherein the at least one command interface is capable of receiving a command and triggering a processing corresponding to the command to be performed on the image.

An apparatus for manipulating and presenting images included in webpages may include: a browser window presenting module, a receiving module, a window establishing module and an image manipulating module;

the browser window presenting module is configured to load a webpage which includes at least one image;

the receiving module is configured to receive a request for manipulating an image in the webpage;

the window establishing module is configured to establish a window which includes at least one command interface for image manipulation, identify the image based on the request, load the image into the window to display the image in the window;

wherein the receiving module is further configured to receive a command via one of the at least one command interface, and providing the command to the image manipulating module; and

the image manipulating module is configured to perform a processing corresponding to the command provided by the receiving module on the image and load the processed image into the window established by the window establishing module to present the processed image in the window.

A non-transitory computer-readable storage medium may include a set of instructions for manipulating and presenting images included in webpages, the set of instructions to direct at least one processor to perform acts of:

loading a webpage which includes at least one image by a processor;
receiving a request for manipulating an image which is one of the at least one image included in the webpage, establishing a window which includes at least one command interface for image manipulation by a processor;

identifying the image in the webpage based on the request, loading the image into the window and presenting the image in the window;

receiving, by the at least one command interface, a command and triggering a processing corresponding to the command to be performed on the image.

It can be seen from the above technical scheme that embodiments of the present disclosure provide a mechanism of manipulating an image in a webpage. After loading a webpage including an image, a browser receives a request for manipulating the image in the webpage, establishes a window which includes at least one command interface for image manipulation; identifies the image in the webpage based on the request, and loads the image into the window to display the image in the window. The window has at least one command interface corresponding to at least one manipulating methods for manipulating images thus enables the user to manipulate the image displayed in the window by using the manipulating methods provided by the window.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating an example of a computer;

FIG. 2is a flowchart illustrating a method for manipulating and presenting images in webpages according to an embodiment of the present disclosure;

FIG. 3is a flowchart illustrating a method for manipulating and presenting image in webpages according to an embodiment of the present disclosure;

FIG. 4is a schematic diagram illustrating obtaining an image in a webpage according to an embodiment of the present disclosure;

FIG. 5is a schematic diagram illustrating a semi-transparent window in which an image is loaded according to an embodiment of the present disclosure;

FIG. 6is a schematic diagram illustrating an apparatus for manipulating and presenting images in webpages according to an embodiment of the present disclosure;

FIG. 7 is a schematic diagram illustrating an apparatus for manipulating and presenting images in webpages according to an embodiment of the present disclosure.

### EMBODIMENTS

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

Various embodiments of the present disclosure provide functions of manipulating an image in a webpage, e.g., in an application in a computer, a browser in a client device and the like. After loading a webpage including an image, an application, e.g., a browser, receives a request for manipulating the image, establishes a window having at least one command interface for image manipulation; identifies the image based on the request, loads the image into the window to present the image in the window. The window that has the command interface for image manipulation enables the user to manipulate the image in the window by using a manipulating method provided by the window and to perform operations on the image, e.g., zooming, rotating, tone adjusting, transparency adjusting and so on.

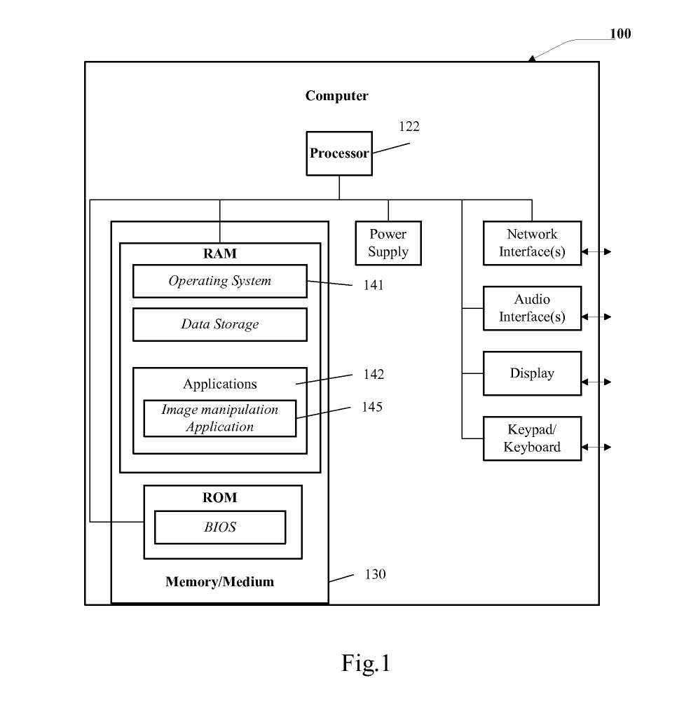

In an example, a computer may execute methods and software systems according to the present disclosure. FIG. 1 is a schematic diagram illustrating an example of a computer. A computer 100 may be a computing device capable of executing a method and an apparatus of the present disclosure. The computer 100 may, for example, be a device such as a personal desktop computer or a portable device, such as a laptop computer, a tablet computer, a cellular telephone, or a smart phone. The computer 100 may also be a server that connects to the above devices locally or via a network.

The computer 100 may vary in terms of capabilities or features. Claimed subject matter is intended to cover a wide range of potential variations. For example, the computer 100 may include a keypad/keyboard. It may also comprise a display, such as a liquid crystal display (LCD), or a display with a high degree of functionality, such as a touch-sensitive color 2D or 3D display. In contrast, however, as another example, a web-enabled computer 100 may include one or more physical or virtual keyboards, and mass storage medium 130.

The computer 100 may also include or may execute a variety of operating systems 141, including an operating system, such as a Windows™ or Linux™, or a mobile operating system, such as iOS™, Android™, or Windows Mobile™. The computer 100 may include or may execute a variety of possible applications 142, such as an image manipulation application 145. An application 142 may enable communication with other devices via a network, such as communicating with another computer via an Internet network for online electronic games.

Further, the computer 100 may include one or more non-transitory processor-readable storage media 130 and one or more processors 122 in communication with the non-transitory processor-readable storage media 130. For example, the non-transitory processor-readable storage media 130 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 130 may store sets of instructions, or units and/or modules that comprise the sets of instructions, for conducting operations described in the present application. The one or more processors may be configured to execute the sets of instructions and perform the operations in example embodiments of the present application.

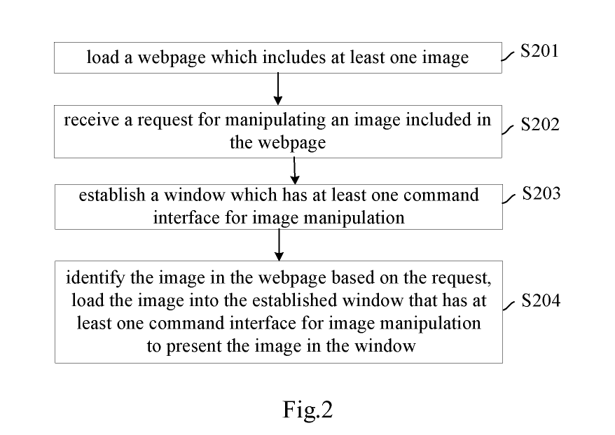

FIG. 2is a flowchart illustrating a method for manipulating and presenting images in webpages according to an example of the present disclosed image manipulation application. The process may include the following procedures.

In block 201, a webpage which includes at least one image is loaded.

In block 202, a request for manipulating an image in the webpage is received.

In block 203, a window which includes at least one command interface for image manipulation is established.

In this block, a window which has a window identification is established on top of a window presenting the webpage. At least one manipulating method corresponding to the at least one command interface for image manipulation is configured in the window established.

In this block, the window established is a semi-transparent window or a transparent window. The command interface for image manipulation has been configured in advance, e.g., command interfaces capable of zooming, rotating, tone adjusting, transparence adjusting and the like may be configured.

In block 204, the image in the webpage is identified based on the request, and the image is loaded into the window having the command interface to present the image in the window.

In an example, a specified interface for processing the user interface is configured. The specified interface detects a click on an area in the webpage, obtains a tag of the area, determines an image is presented in the area, obtains an address of the image from the tag of the area, obtains the image from the address and stores the image in a local location; obtains the image stored in the local location, loads the image into the window that has the command interface by using an image loading interface of the window to present the image in the window.

In an example, the at least one command interface is capable of receiving a command and triggering a processing corresponding to the command to be performed on the image. The user is thus enabled to manipulate the image in the window by using the manipulating methods provided by the window.

In an example, the step of establishing a window that has a command interface for image manipulation and the step of loading the image into the window are both carried out by using a Microsoft window configuring interface.

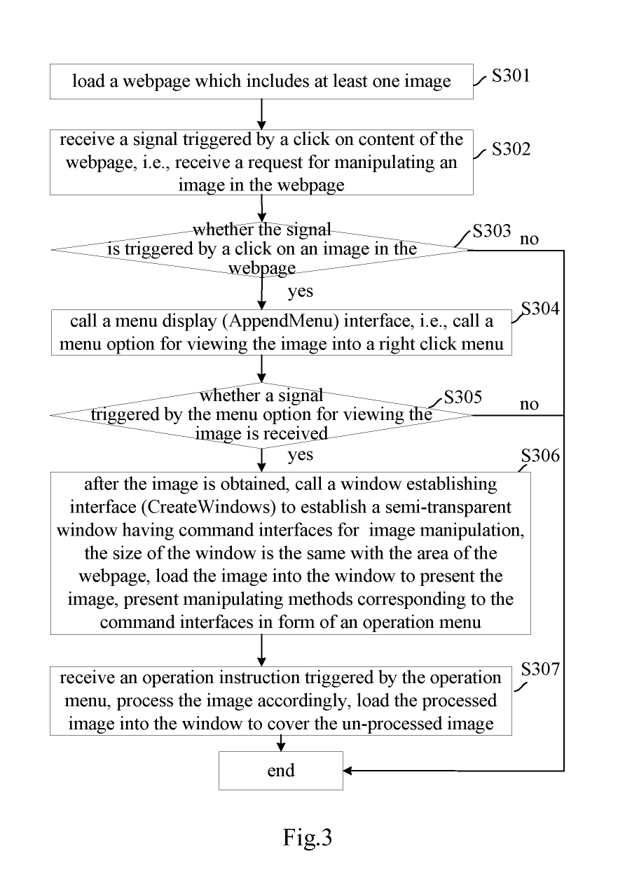

FIG. 3is a flowchart illustrating a method for manipulating and presenting an image in a webpage according to an example of the present disclosed image manipulation application. In an example, a browser in a client device is configured with functions of manipulating an image in a webpage. The functions are used in the following process. The process may include the following procedures.

In block 301, a webpage which includes an image is loaded.

In block 302, a signal triggered by a click on content of the webpage is received, i.e., a request for manipulating the image in the webpage is received.

In an example, a browser in a client device is configured with a receiving interface. The browser may receive the signal triggered by a click on the content of the webpage via the receiving interface.

In an example, the signal triggered by a click on the content of the webpage is sent by the user via a right mouse button or a left mouse button or a touch screen and the like. Taking a signal generated by a right mouse button as an example, the browser in the client may detect the signal by using an interface, e.g., IDocHostUIHandler: ShowContextMenu.

In block 303, it is judged whether the signal is triggered by an operation on an image in the webpage, and the procedure in block 304 is performed in response to a determination that the signal is triggered by an operation on an image in the webpage, or the process is terminated in response to a determination that the signal is not triggered by an operation on an image in the webpage.

In block 304, a menu displaying interface (AppendMenu) is called, i.e., calling a menu option for viewing an image into a right-click menu of the mouse.

In block 305, it is judged whether a signal triggered by a menu for viewing an image is received, the procedure in block 306 is performed in response to a determination that a signal triggered by a menu for viewing an image has been received, or the process is terminated in response to a determination that the signal triggered by a menu for viewing an image has not been received.

In block 306, after the image in the webpage is obtained, a window creating interface (e.g., CreateWindows) is called to establish a window that has an interface for image manipulation. The window has the same size with the area of the webpage, and is semi-transparent. The image is loaded into the window and presented. The manipulating methods corresponding to the interface for image manipulation are displayed in an operation menu.

In block 307, an operation instruction triggered by an action on the operation menu is received, an operation corresponding to the operation instruction is performed on the image, and the processed image is loaded into the window to cover the un-processed image. Then the process is terminated.

The browser in the client may be configured by using the C++ language to make the browser have the functions of manipulating images included in a webpage.

In an embodiment, the step of receiving a signal triggered by a click on content of a webpage in block 302 as shown in FIG. 3may include detecting an area in the webpage that is clicked on by a right mouse button by using an IDocHostHandler interface of a browser in a client, e.g.,

IDocHostUIHandler::ShowContextMenu (DWORD dwID, POINT *ppt, IUnknown *pcmdTarget, IDispatch *pdispReserved) //when detecting a click on a right mouse button, the browser in the client calls the function; the *pdispReserved is a pointer pointing to the content clicked on; an IHTMLElement interface may be queried by calling a QueryInterface function of the browser, then a tag of the content may be obtained by calling a get_tagName function; it is determined that the content clicked on is an image in response to a determination that the tag name obtained represents an image (e.g., IMG);

CComPtr<IHTMLImgElement>spEmg; //defining the content clicked
on PELement−>QueryInterface (IID_IHTMLImgElement, (void**)
&spEmg);

//querying the content clicked on

...
CComBSTR bstrTagName; //defining a string for a tag name
PElement−>get_tagName (&bstrTagName); // obtaining an HTML

tag of the content clicked on.

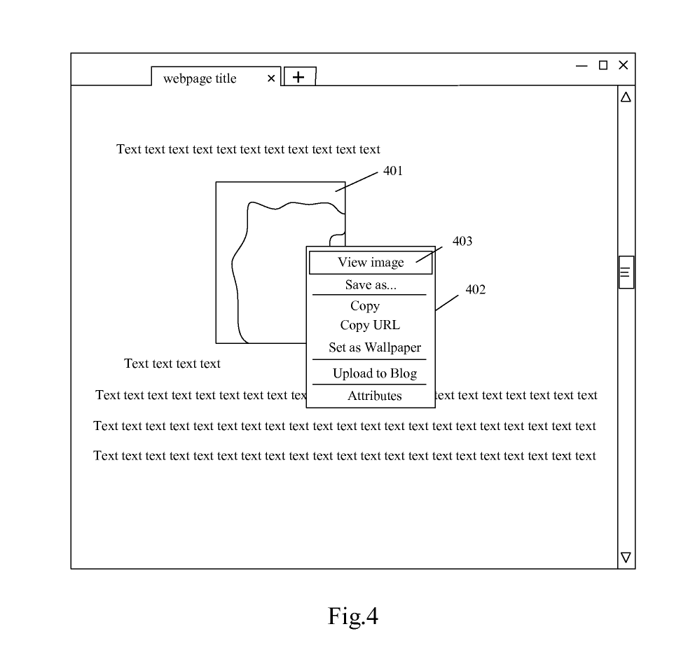

In an embodiment, the step of calling a menu option for viewing an image into the right mouse button menu may include adding a menu option “view the image” into the right mouse button menu of the above ShowContextMenu interface after the browser determines the image in the webpage is clicked on by a right mouse button, as shown in FIG. 4. FIG. 4is a schematic diagram illustrating obtaining an image in a webpage according to an embodiment of the present disclosure. As shown in FIG. 4, in response to a click on an image 401, a menu 402, e.g., a right-click menu, is provided. A menu option, e.g., the “View image” option 403, is added in the menu 402 so that the user may trigger an image presenting process as described in below.

AppendMenu (hMenu, MF_STRING|MF_POPUP, IDM_SHOW_IMAGE, L” view image”); //adding a menu option “view image” into the right-click menu.

In an example of block 305 of FIG. 3, when the user clicks on the “view image” menu option, the browser of the client extracts the image in the webpage. The process may include: the browser extracts the image by using a GetUrlCacheEntryInfo interface according to a src attribute in a tag of the image, and caches the image into a local location. The src attribute is the unique identification of the image. In an example, the process may include:

CComBSTR bstrUrl; // define an address of the image
PimgElement−>get_src (&bstrUrl); // obtain the address of the image
...
LPINTERNET_CACHE_ENTRY_INFO 1pCacheEntry=NULL; //

define cache information of the image, obtain the local location of the
image

...
GetUrlCacheEntryInfo (strUrl, lpCacheEntry, &dwLen); // obtain

cache information of the image

IpCacheEntry.IpszLocalFileName // local location of the image

In the above mechanism, the user may obtain the image through other manners instead of using the right mouse button. The other manners may include, but not limited to: by using a left mouse button, a mouse movement, a touch on a touch screen, the tab key, or by listing all images in a webpage for the user to choose from, and the like.

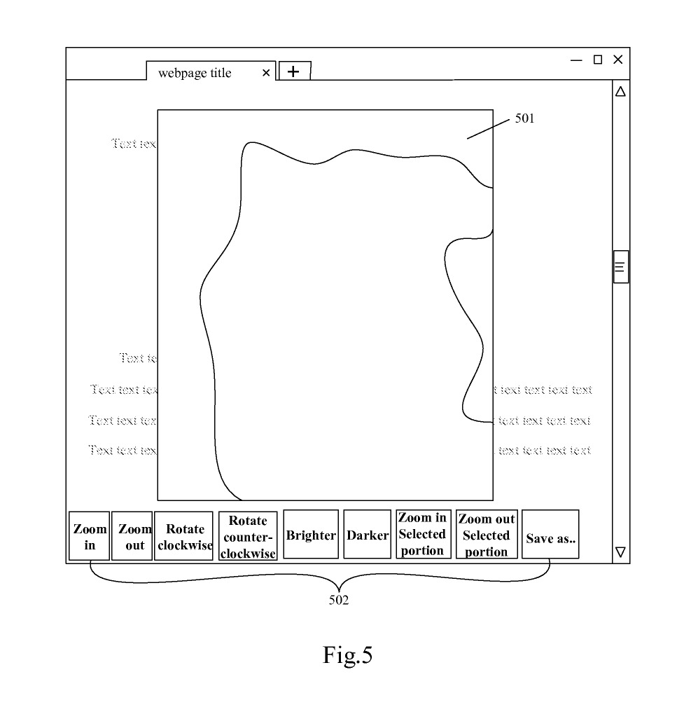

In an example of block 306 of FIG. 3, the browser of the client may establish a semi-transparent window. The size of the window is the same with the size of the displaying area of the webpage. The window is placed on top of the webpage and serves as a workbench for processing the image. FIG. 5 is a schematic diagram illustrating a semi-transparent window in which an image is loaded according to an example of the present disclosure. As shown in FIG. 5, an image 501 is loaded into the semi-transparent window, and multiple buttons 502 for multiple manipulating operations are provided at the bottom of the window. The manipulating operations may include, but not limited to: zooming the whole image, rotating the image, adjusting the color of the image, adjusting the transparency of the image, zooming a portion of the image, and/or adjusting the exposure of the image and so on. After performing certain manipulating operations on the image, the user may obtain an image with expected effects and may store the processed image into a local machine, as shown in FIG. 5. The displaying effects of the image may be manipulated by using (but not limited to) any or any combination of programming languages including JavaScript, HTML, CSS, Delphi, VB, C++ and the like.

In an example, in block 306, a window with a window identification is established on top of the window loading the webpage, manipulating methods corresponding to command interfaces for image manipulation is configured in the window established, obtaining the image from a local storage according to a local location of the image and loads the image into the window having the command interfaces by using a loading interface of the window. The following is an example of configuring the window by using various interfaces.

HWND WINAPI Create Window // establish a semi-transparent

window and a menu bar window with buttons

LPCTSTR IpClassName // the type of the window
LPCTSTR IpWindowName // the title of the window
DWORD dwStyle // the style of the window
int x, // the initial x-coordinate of the window
int y, // the initial y-coordinate of the window
int nWidth // the width of the window
int nHeight // the hight of the window
HWND hWndParent // the parent window of the window
HMENU hMenu // the identification of the window
HINSTANCE hInstance // program handle
LPVOID IpParam // parameters of the window and a drawing
function
Static Bitmap* FromFile // load the image
WCHAR *filename // image path

In this process, the window may not be necessarily established. Instead, buttons providing manipulating methods may be provided along an edge of the image, e.g., at the lower edge of the image. Thus, the user may use the buttons to manipulate the presenting effects of the image.

After the image is presented according to the mechanism as shown in FIG. 3, the user may click on the ESC key. The browser of the client receives the signal triggered by the ESC key via a specified interface for processing the user interface configured in the browser, then closes the window established. Then the user may continue to browse the webpage using the browser.

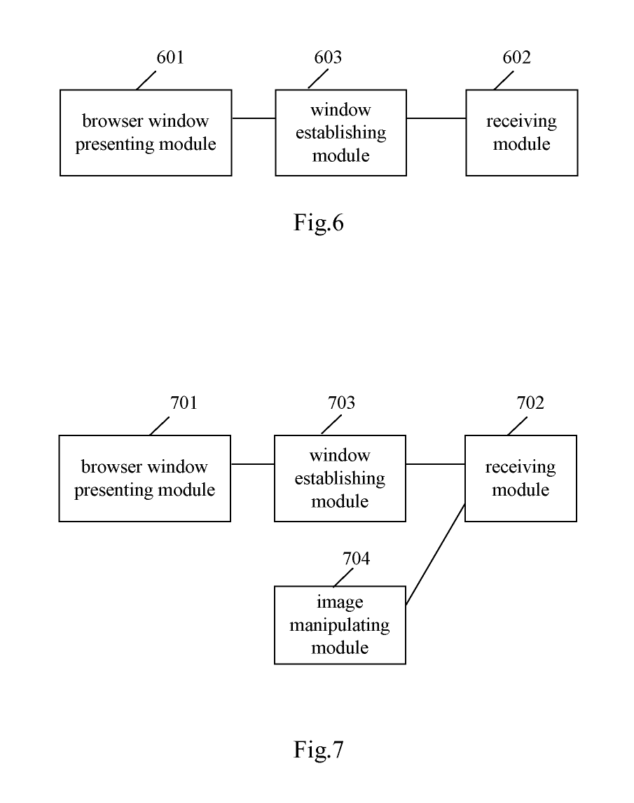

FIG. 6is a schematic diagram illustrating a structure of an apparatus for manipulating and presenting an image included in a webpage. The apparatus may include: a browser window presenting module 601, a receiving module 602 and a window establishing module 603.

The browser window presenting module 601 may load a webpage which includes at least one image.

The receiving module 602 may receive a request for manipulating an image in the webpage.

The window establishing module 603 may establish a window which includes at least one command interface for image manipulation, identify the image based on the request, load the image into the window to display the image in the window.

In an example of the apparatus, the window establishing module 603may include a sub window unit for establishing the at least one command interface. The sub window unit may establish a window with a window identification on top of a window loading the webpage, and configure at least one manipulating method corresponding to the at least one command interface in the window established.

In an example, the window establishing module 603 may include a request processing unit. The request processing unit may set up a specified interface for processing the user interface, identifies a click on an area of the webpage, obtain a tag of the area, determine an image is presented in the area, obtain an address of the image from the tag of the area, extract the image from the address and store the image in a local location.

In an example, the window establishing module 603 may include an image presenting unit. The image presenting unit may load the image into the window that has at least one command interface for image manipulation by using a loading interface of the window to present the image in the window after the image stored in the local location is obtained from the local location where the image is stored.

FIG. 7 is a schematic diagram illustrating a structure of an apparatus for manipulating and presenting an image included in a webpage. The apparatus may include: a browser window presenting module, a receiving module, a window establishing module and an image manipulating module704.

The browser window presenting module 701, the receiving module 702and the window establishing module 703have similar functions with the above browser window presenting module 601, the receiving module 602and the window establishing module 603 respectively.

The receiving module 702 may also receive a command via one of the at least one command interface, and providing the command to the image manipulating module 704.

The image manipulating module 704 may perform a processing corresponding to the command provided by the receiving module on the image and load the processed image into the window established by the window establishing module 703 to present the processed image in the window.

In an example, the apparatus is a computer that has a processor and memory. The modules are within the memory in the form of computer-readable instructions.

It should be understood that in the above processes and structures, not all of the steps and modules are required. Certain steps or modules may be omitted according to the needs. The order of the procedures is not fixed, and can be adjusted according to the needs. Those skilled in the art can understand the modules in the apparatus of embodiments of the present invention may be located in the apparatus as described in the embodiments, or may be located in one or more apparatuses of the embodiments of the present invention when modified accordingly. The modules in embodiments of the present invention may be combined into one module, or may be further divided into multiple sub modules.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which is to store instructions to cause a machine to execute the technical scheme as disclosed herein. Specifically, a system or apparatus having a storage medium which stores machine-readable program codes for implementing functions of any of the above examples (e.g., providing for loading a webpage which includes at least one image by a processor; providing for receiving a request for manipulating an image included in the webpage, providing for establishing a window which includes at least one command interface for image manipulation by a processor; providing for identifying the image in the webpage based on the request, providing for loading the image into the window and providing for presenting the image in the window, and so on). The storage medium may make the system or the apparatus (or CPU or MPU) read and execute the program codes stored in the storage medium. In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

1. A method for manipulating and presenting images included in webpages, comprising:
loading a webpage which includes at least one image by a processor;
receiving a request for manipulating an image which is one of the at least one image included in the webpage, establishing a window which includes at least one command interface for image manipulation by a processor;
identifying the image in the webpage based on the request, loading the image into the window and presenting the image in the window;
wherein the at least one command interface is capable of receiving a command and triggering a processing corresponding to the command to be performed on the image.

2. The method of claim 1, wherein establishing a window which includes at least one interface for manipulating the image comprises:
establishing a window which has a window identification on top of the window presenting the webpage by a processor, configuring in the window at least one manipulating method corresponding to the at least one command interface for manipulating the image by a processor.

3. The method of claim 1, wherein identifying the image in the webpage based on the request comprises:
setting up a specified interface for processing a user interface; identifying, by the specified interface using a processor, a click on an area of the webpage, obtaining a tag of the area, determining that an image is presented in the area by a processor, obtaining an address of the image from the tag of the area by a processor, obtaining the image from the address and storing the image in a local location by a processor.

4. The method of claim 3, wherein loading the image into the window and presenting the image in the window comprises:
obtaining the image stored in the local location where the image is stored by a processor, loading the image into the window that has at least one command interface by using a loading interface of the window, and presenting the image in the window by a processor.

5. An apparatus for manipulating and presenting images included in webpages, comprising: a browser window presenting module, a receiving module, a window establishing module, and an image manipulating module; wherein
the browser window presenting module is configured to load a webpage which includes at least one image;
the receiving module is configured to receive a request for manipulating an image which is one of the at least one image included in the webpage;
the window establishing module is configured to establish a window which includes at least one command interface for image manipulation, identify the image based on the request, load the image into the window to present the image in the window;
wherein the receiving module is further configured to receive a command via one of the at least one command interface, and providing the command to the image manipulating module; and
the image manipulating module is configured to perform a processing corresponding to the command provided by the receiving module on the image and load the processed image into the window established by the window establishing module to present the processed image in the window.

6. The apparatus of claim 5, wherein the window establishing module comprises a sub window unit configured to establish the at least one command interface; the sub window unit is configured to establish a window with a window identification on top of a window presenting the webpage, and configure at least one manipulating method corresponding to the at least one command interface in the window established.

7. The apparatus of claim 5, wherein the window establishing module comprises a request processing unit, configured to set up a specified interface for processing a user interface, identify a click on an area of the webpage, obtain a tag of the area, determine an image is presented in the area, obtain an address of the image from the tag of the area, extract the image from the address and store the image in a local location.

8. The apparatus of claim 7, wherein the window establishing module may include an image presenting unit, configured to load the image into the window that has at least one command interface for manipulating the image by using a loading interface of the window to present the image in the window after the image is obtained from the local location.

9. A non-transitory computer-readable storage medium comprising a set of instructions for manipulating and presenting images included in webpages, the set of instructions to direct at least one processor to perform acts of:
loading a webpage which includes at least one image by a processor;
receiving a request for manipulating an image which is one of the at least one image included in the webpage, establishing a window which includes at least one command interface for image manipulation by a processor;
identifying the image in the webpage based on the request, loading the image into the window and presenting the image in the window;
receiving, by the at least one command interface, a command and triggering a processing corresponding to the command to be performed on the image.

10. The non-transitory computer-readable storage medium of claim 9, wherein the establishing a window which includes at least one interface for manipulating the image comprises:
establishing a window which has a window identification on top of the window presenting the webpage by a processor, configuring in the window at least one manipulating method corresponding to the at least one command interface for manipulating the image by a processor.

11. The non-transitory computer-readable storage medium of claim 9, wherein identifying the image in the webpage based on the request comprises:
setting up an interface for processing the user interface; identifying, by the specified interface for processing the user interface, a click on an area of the webpage, obtaining a tag of the area, determining that an image is presented in the area by a processor, obtaining an address of the image from the tag of the area by a processor, obtaining the image from the address and storing the image in a local location by a processor.

12. The non-transitory computer-readable storage medium of claim 11, wherein loading the image into the window and presenting the image in the window comprises:
obtaining the image stored in the local location where the image is stored by a processor, loading the image into the window that has at least one command interface by using a loading interface of the window, and presenting the image in the window by a processor.
